(19) United States
(12) Patent Application Publication
(10) Pub. No.: US 2002/0066168 A1
(43) Pub. Date: Jun. 6, 2002

(54) Embalming fluid

(76) Inventor: Dermot Christopher John Barrow, East Sussex (GB)

Correspondence Address: BROWDY AND NEIMARK, P.L.L.C., 624 Ninth Street, N.W., Washington, DC, 20001, US

(21) Appl. No.: 09/809,433

(22) Filed: Mar. 16, 2001

(30) Foreign Application Priority Data
Dec. 1, 2000 (GB) 0029410.8

(51) Int. Cl. A01N 1/00

(52) U.S. Cl. 27/22.2; 27/22.1

(57) ABSTRACT

An embalming fluid is provided which is free from formaldehyde. The preferred disinfectant is an iodine-based disinfectant, polyvinylpyrrolidone-iodine being particularly preferred.

Embalming methods are also disclosed, together with kits for use in preparing an embalming fluid in accordance with the invention and concentrated forms of the fluid.

### FIELD OF THE INVENTION

This invention relates to an embalming fluid for use in an embalming process.

### BACKGROUND OF THE INVENTION

Embalming was developed and widely practised in ancient Egypt where, from around 6000 BC to 600 AD, 400 million bodies were mummified. The processes involved in traditional Egyptian embalming have led to the remarkable preservation of many bodies.

The embalming process nowadays differs markedly from the religious practices of ancient Egypt; the purpose is partly cosmetic (to improve the appearance of the body, and thereby reduce the distress caused to relatives of the deceased) and partly preservative, although the main aim is to ensure that the body remains in a hygienic condition during the period up to burial or cremation, rather than providing long-lasting preservation of the tissues.

The modern embalming process involves flushing out the blood from the circulatory system of the body and replacing it with an embalming fluid which has a stabilising and protecting action on the body. The embalming fluid is injected into the arterial system of the cadaver and directly into some organs. Displaced body fluids are treated and disposed of via the public sewerage system or more usually by a contracted disposal firm.

The normal steps in the modern embalming process are as follows:

The body is placed in a proper position on the embalming table with the arms laid over the stomach.

The body is washed and disinfected.

The face is shaved as necessary.

The eyes are closed. This is usually accomplished with a small curved plastic disc called an “eye cap” placed under the eyelid. Perforations in the cap are sometimes present to help hold the eye lid in place.

The mouth is closed. This is usually accomplished by the placing of a specially designed “tack” in the upper and lower jaw. Each tack has a fine wire attached. By twisting the two wires together, the jaw is thus closed and the lips are set to the natural lip line using a cream to retain the proper position and to prevent dehydration.

The lower body orifice(s) may be plugged to prevent leakage.

The embalming solution is prepared. The modern embalming machine consists of a 2-3 gallon reservoir and an electric pump.

An incision is made over the carotid artery (where the neck meets the shoulder) or over the femoral artery (in the leg at the groin). The artery and a nearby vein are located and isolated.

A tube which is attached to the machine is inserted into the artery. A slightly larger tube is placed into the accompanying vein. This tube is attached via a hose to a collecting tank.

The fluid is injected into the artery under pressure by the embalming machine. As the blood is displaced by the fluid going in, it is forced out of the body from the vein and is disposed of. The pressure forces the embalming fluid into the capillaries and eventually to the cells of the body. After sufficient solution (typically approximately 1-3 liters) of solution are injected into the body, the blood has thinned and the fluid coming through the vein tube is mostly embalming fluid.

The tubes are removed and the incision sutured.

The abdominal cavity is treated by the use of a hollow tube called a trocar that is used to aspirate gases and liquid contents under suction. A preservative chemical—generally a more concentrated solution of the embalming fluid—is introduced.

The body is again washed and cream is placed on the hands and face to prevent dehydration.

The hair is shampooed and the finger nails cleaned.

The body is covered with a sheet awaiting dressing and placement in the casket.

Cosmetics may be applied later to improve the natural colour of the body, although this will be less important if the embalming fluid includes a colorant. Much of the natural colour is created by blood in facial capillaries—this is no longer present after embalming. In the case of women, cosmetics used in life may also be used to recreate the “look” the person had during life. The hair is combed or set.

The foregoing sequence of steps is given for the purpose of illustration only and is not intended to be limiting on the invention. Embalming fluids in accordance with this invention will be administered in accordance with the professional judgment of the embalmer.

The earliest modern embalming fluids contained arsenic, but these solutions were soon replaced by formaldehyde-based embalming fluids. Despite its unpleasant and dangerous properties, the use of formaldehyde in embalming has become almost universal.

Formaldehyde acts as a chemical fixing agent, reacting with the soluble albumins (proteins) in the cells of the body and converting them to albuminoids which are gels. By pumping a formaldehyde solution through the vascular system of a body, the chemical agent perfuses into the tissues and exerts its disinfecting and preservative functions.

Formaldehyde is obtained commercially as a ca. 28% solution and this is diluted down by the funeral director or embalmer to ca. 2-3% concentration. Typically, 2-3 liters of diluted solution are used per embalming.

Formaldehyde-based embalming fluids may or may not contain other chemicals such as colorants, humectants, disinfectants, pH stabilisers, etc.

Formaldehyde has long been used in the embalming profession as it confers excellent preservative properties on the body and is an effective disinfectant and anti-microbial agent.

Although formaldehyde is very effective in preserving tissues for the timescale required, it is nevertheless a very hazardous material; it is highly toxic when inhaled and possesses irritant properties when in contact with the skin or eyes. It also has carcinogenic activity and has been linked to many different forms of cancer—nasal, lung, testicular and brain cancer as well as leukaemia. Studies conducted by the National Cancer institute in the USA have shown that embalmers were at greater risk for leukaemia, testicular and brain cancer than the general population.

The permitted limit of exposure to formaldehyde has been gradually reduced and funeral directors and embalmers have to work in an environment where rapid changes of air are possible.

In addition, the disposal of formaldehyde can create problems as it should not enter sewerage systems or water courses. Its effect on soil and soil organisms is not certain, but formaldehyde has been shown to be toxic to fish and related species when introduced into water systems. Recommended disposal is via incineration.

There is therefore a long term problem both for the environment and for the embalmer himself in using formaldehyde as an embalming fluid. Consequently there is a need for an embalming fluid which is free from formaldehyde.

Accordingly, this invention aims to provide a formaldehyde-free embalming fluid that is non-toxic, easy to make up and use, effective, and which is also environmentally acceptable and biodegradable.

### SUMMARY OF THE INVENTION

According to one aspect of the present invention, there is provided an embalming fluid free of formaldehyde, which fluid comprises:

(a) a vegetable-based, water-soluble polymer;

(b) a non-toxic disinfectant which is free from formaldehyde; and

(c) demineralised water,

optionally with conventional additives, e.g. one or more perfumes and colorants.

According to a second aspect, the present invention provides a method of manufacture which comprises the use of a vegetable-based, water-soluble polymer and a non-toxic, iodine-based disinfectant in the formulation of an embalming fluid which is free from formaldehyde.

According to a fourth aspect of this invention, there is provided a method of embalming, which comprises injecting to the body which is to be embalmed a fluid in accordance with the invention. The body may be a human or an animal body.

The vegetable-based polymer advantageously produces a pseudoplastic solution when dissolved in water. Preferably the polymer is a sodium alginate. These are hydrophilic polysaccharides consisting of blocks of D-mannuronic acid linked in the β configuration through the 1- and 4- positions and L-guluronic acid units linked in the α configuration through the 1- and 4- positions.

The currently preferred polymer is the material “Algin I-S” manufactured and distributed by Kimitsu Chemical industries Co., Ltd. and is a white free-flowing powder, which is odourless and tasteless. An aqueous solution containing 1% by weight of this product has a viscosity of ca. 950-1100 centipoise (mPa.s) at 20° C.

The preferred product is readily available, is derived from a renewable natural resource and is fully and readily biodegradable.

The vegetable-based polymer has pseudoplastic properties which make for ease of preparation and injection but give some thickening when the force is removed. It also contributes some antiseptic benefits.

The disinfectant is preferably iodine-based, and polyvinylpyrrolidone-iodine is especially preferred. This material has a broad antimicrobial spectrum and is readily available; it is sometimes known as “PVP iodine”. Bacteria, viruses, bacterial endospores and fungi are destroyed through oxidative interaction and direct iodination of biological macromolecules. Polyvinylpyrrolidone-iodine is available from varous commercial sources including Fisher Scientific of Pittsburgh, USA and Fisher Scientific UK Ltd. of Loughborough, England.

The perfume should be a naturally based material, preferably a fragrant oil, e.g. rose oil (Rosa centifolium), sandalwood oil (Santalum album) or geranium oil (Pelargonium graveolens), which may be incorporated in dilute form. Other suitable fragrances include chrysanthemum oil and freesia oil. Such materials are readily available; a suitable source for rose oil and sandalwood oil is, for example, Elixir Aromatherapy & Natural Health Limited of Tonbridge, Kent (England).

A colorant is preferably added to give a more realistic skin colour to the cadaver; the colorant used will vary depending on the ethnic origin of the cadaver. The colorant should be a natural vegetable dye, preferably cochineal. Suitable colorants are readily available commercially, e.g. from Warner Jenkinson of St. Louis, Mo. or from Cyber-Colors Ltd. of Monkstown, Co. Cork, Ireland.

Demineralised water is preferred for formulating an embalming fluid in accordance with this invention because it prevents the unintentional incorporation of bacteria into the cadaver which may occur if tap water is used.

The components of the embalming fluid of this invention will be combined in appropriate proportions; in particular, the quantities of the polymer component and the disinfecting component will be selected according to the site into which the embalming fluid is to be injected. Conventionally, more concentrated solutions are injected into the major organs of the body, while more dilute solutions are injected into the vascular system.

Preferably, the ratio (by weight) of polymer to disinfectant is in the range from 0.6:1 to 1:1.5 when the polymer is a sodium alginate and the disinfectant is PVP-iodine; approximately equal proportions by weight are most preferred.

In one embodiment, the invention provides an embalming fluid free of formaldehyde, which fluid comprises:

(a) a sodium alginate polymer;

(b) polyvinylpyrrolidone-iodine; and

(c) demineralised water, optionally with conventional additives, e.g. one or more perfumes and colorants, and the ratio (by weight) of polymer to disinfectant being in the range from 0.6:1 to 1:1.5.

The embalming fluid typically comprises about 0.05-3% by weight of the vegetable-based polymer, about 0.05-3% by weight of the disinfectant, about 0.1-1% of perfume, about 0.1-1% by weight of colorant and the balance being demineralised water.

Generally, the embalming fluid comprises 0.1-2% by weight of the vegetable-based polymer, 0.1-2% by weight of the disinfectant, 0.1-1% of perfume, 0.1-1% by weight of colorant and 94-99.5% by weight of demineralised water. The currently preferred formulation is 1% by weight of the vegetable-based polymer “Algin I-S” from Kimitsu Chemical Industries Co., Ltd.; 1% by weight of the disinfectant polyvinylpyrrolidone-iodine from Fisher Scientific of Loughborough, England; 0.3% by weight of perfume; 0.7% by weight of colorant; and 97% by weight of demineralised water.

The major organs of the body will usually be injected with a more concentrated solution, typically 2-4 times the concentration of that used for the vascular system; the limiting concentration of solution is determined by the viscosity of the embalming fluid.

According to a third aspect of the present invention, there is provided a kit for use in formulating a formaldehyde-free embalming fluid, the kit comprising, in packaged form, an alginate polymer; an iodine-based disinfectant; a perfume; and a colorant.

According to a fourth aspect of the present invention, there is provided a concentrated solution for use, when diluted with demineralised water, as an embalming fluid, wherein the concentrated solution is free from formaldehyde and comprises 0.5-20% by weight of a vegetable-based polymer; 0.5-20% by weight of an iodine-based disinfectant; 0.5-10% by weight of a perfume; and 0.5-10% by weight of a colorant, the balance being demineralised water.

A preferred method of making up an embalming fluid in accordance with this invention will now be described.

The demineralised water is taken and the disinfectant, perfume and colorant added whilst stirring gently with a mechanical stirrer having a propeller type stirring blade. The stirring is increased to give a vortex in the solution and the vegetable-based polymer is added slowly and carefully and stirring continued with decreasing speed until all the polymer dissolves and thickens the water. Stirring is discontinued when all the solid has dissolved and the solution is then left to stand to equilibrate to ambient conditions.

The embalming fluid of this invention is a natural-based composition; it is odourless and non-toxic. It can be used without risk of irritation to skin, mouth and nasal passages. It obviates the need for excessive air changes in the embalming room.

The embalming fluid has proved successful in the treatment and preparation of cadavers prior to the funeral. Natural skin colours can be maintained and there were no unpleasant odours present.

No deterioration of the cadaver was recorded over a 7 day period (average).

Cadavers have been held for up to 7 days under refrigeration conditions without deterioration. It is estimated that under refrigeration, very extended periods would prove to present few problems. Tests were also carried out with no refrigeration for a period of 21 days after treatment. After 18 days some leakage was noted from the rectum but no packing had been used under the test conditions. The body began to deteriorate after this time period but not too seriously. Barometric pressure at this period was unusually low, with thunder, the ambient temperature being 12-14° C.

We have also observed that where patients have been treated prior to death with chemotherapy, hydrocortisone or insulin injections, the accelerated breakdown of tissue which usually occurs in the cadaver can be prevented by increasing the concentration of the embalming fluid—typically by 1% for each of the polymer and disinfectant components (for example 2.5% by weight each of Algin I-S and of PVP-iodine).

The invention will be illustrated in a non-limiting manner by the following Example.

### EXAMPLE 1

The body of a 53-year old Caucasian female weighing 140 lbs (64 kg)] was embalmed using an embalming fluid in accordance with this invention. The embalming process took place five days after the woman had died from carcinomatosis, the cadaver having been refrigerated at +2° C. during this time. Rigor mortis had relaxed and the body was easily manouvrable when the embalming took place.

The embalming fluid consisted of a solution in demineralised water of the following ingredients:

1: Algin I-S—(Kimitsu Chemical Industries Co., Ltd.);

2: PVP-iodine—(Fisher Scientific);

3: Rose oil—(Elixir Aromatherapy & Natural Health); and

4: Carmine—(Cyber-Colors Ltd.).

The relative proportions of these ingredients, by weight, was 1:2:3:4=10:10:3:7.

The major proportion of the fluid used was made up with demineralised water to give a solution having 3 parts by weight of the above ingredients and 97 parts by weight water. A smaller amount of solution at twice this concentration (6 parts by weight of the above ingredients and 94 parts by weight water) was also used.

The body was washed prior to the embalming process and the rectum was plugged using an absorbent pad which had been immersed in the embalming fluid.

2 liters of the normal concentration embalming fluid were pumped into the vascular system of the cadaver, after which time the venous effusion was composed of embalming fluid rather than blood. 0.3 liters of the more concentrated fluid was then injected by means of a trocar into the abdominal cavity. The total quantity of fluid injected was thus 2.3 liters.

During the embalming process, the embalmer was wearing surgical (latex) gloves instead of the heavy, protective type needed when an embalming fluid based on formaldehyde is used. This permits greater dexterity and hence allows the embalming to proceed more readily.

Immediately after the embalming process had been completed, the cadaver had a natural skin tone and showed no signs of discoloration. There was no unpleasant odour.

The cadaver was kept at a temperature of 7° C. for a period of seven days after which the skin tone was still natural in appearance, and the skin retained its suppleness. There was no evidence of discoloration or of deterioration of the tissue. There was still no unpleasant odour (a mild floral fragrance was evident), and no evidence of seepage of fluids from the body.

### EXAMPLE 2

The body of an elderly male, approximately 80 years old, of average build and 6 ft. tall, was embalmed using an embalming fluid as described in Example 1 above. The embalming took place four days after death, by which time rigor mortis had worn off and hypostasis was evident in the left side of the face, the left arm and hand. Both legs were slightly oedematous and the eyes were very sunken. The site chosen for injection of the embalming fluid was the right common carotid artery.

After one liter of fluid had been injected, it was apparent that the fluid was distributing around the body. Hypostasis was starting to clear and the face—in particular the lips and eyeballs—was filling out to a natural condition.

After 4-liters had been injected, drainage by the “heart tap” method was commenced, the trocar entering the right atrium. Abdominal drainage was also carried out, after which 1 liter of the more concentrated embalming solution was injected into the abdominal cavity.

At the end of the embalming process, the cadaver presented a much improved appearance, with arms, trunk and legs assuming a natural colour. There was no oedema in the legs. The hands were soft and pliable. The face still had some mottled marks, but these were clearing, and the eyes and mouth had a full, natural appearance.

The cadaver was stored for five days prior to burial. After this period, there was no evidence of deterioration, either in terms of appearance or of odour. There was no bruising or discoloration of the tissues. The face, including the eyes, ears and lips, had a natural pink colour which was not evident prior to embalming.

What is claimed is:

1. An embalming fluid free of formaldehyde, which fluid comprises:
(a) a vegetable-based, water-soluble polymer;
(b) a non-toxic disinfectant which is free from formaldehyde; and
(c) demineralised water,
optionally with conventional additives, e.g. one or more perfumes and colorants.

2. An embalming fluid as claimed in claim 1, wherein said disinfectant is an iodine-based disinfectant.

3. An embalming fluid as claimed in claim 2, wherein said disinfectant is polyvinylpyrrolidone-iodine.

4. An embalming fluid as claimed in claim 1, where said polymer is a sodium alginate.

5. An embalming fluid as claimed in claim 1, wherein the fluid comprises about 0.05-3% by weight of the vegetable-based polymer, about 0.05-3% by weight of the disinfectant, about 0.1-1% of perfume, about 0.1-1% by weight of colorant and the balance being demineralised water.

6. An embalming fluid as claimed in claim 1, wherein the ratio (by weight) of polymer to disinfectant is in the range from 0.6:1 to 1:1.5.

7. An embalming fluid free of formaldehyde, which fluid comprises:
(a) a sodium alginate polymer;
(b) polyvinylpyrrolidone-iodine; and
(c) demineralised water,
optionally with conventional additives, e.g. one or more perfumes and colorants, and the ratio (by weight) of polymer to disinfectant being in the range from 0.6:1 to 1:1.5.

8. A method of manufacture which comprises the use of a vegetable-based, water-soluble polymer and a non-toxic, iodine-based disinfectant in the formulation of an embalming fluid which is free from formaldehyde.

9. A method of embalming, which comprises injecting to the body which is to be embalmed a fluid free of formaldehyde, and which comprises:
(a) a vegetable-based, water-soluble polymer;
(b) a non-toxic disinfectant which is free from formaldehyde; and
(c) demineralised water,
optionally with conventional additives, e.g. one or more perfumes and colorants.

10. A method of embalming, which comprises injecting to the body which is to be embalmed a fluid free of formaldehyde, and which comprises:
(a) a sodium alginate polymer;
(b) polyvinylpyrrolidone-iodine; and
(c) demineralised water,
optionally with conventional additives, e.g. one or more perfumes and colorants, and the ratio (by weight) of polymer to disinfectant being in the range from 0.6:1 to 1:1.5.

11. A kit for use in formulating a formaldehyde-free embalming fluid, the kit comprising, in packaged form, an alginate polymer; an iodine-based disinfectant; a perfume; and a colorant.

12. A kit as claimed in claim 11, wherein said polymer is a sodium alginate and said disinfectant is polyvinylpyrrolidone-iodine.

13. A concentrated solution for use, when diluted with demineralised water, as an embalming fluid, wherein the concentrated solution is free from formaldehyde and comprises 0.5-20% by weight of a vegetable-based polymer; 0.5-20% by weight of an iodine-based disinfectant; 0.5-10% by weight of a perfume; and 0.5-10% by weight of a colorant, the balance being demineralised water.

14. An embalming fluid free of formaldehyde, which fluid comprises:
(a) about 0.1-2% by weight of a sodium alginate polymer;
(b) about 0.1-2% by weight of polyvinylpyrrolidone-iodine;
(c) about 0.3% by weight of a perfume; and
(d) about 0.7% by weight of a colorant, the balance being demineralised water.
